(19) United States
(12) Patent Application Publication
(10) Pub. No.: US 2008/0225555 A1
(43) Pub. Date: Sep. 18, 2008

(54) LIGHT GUIDE PLATE, DISPLAY APPARATUS AND ELECTRONIC DEVICE

(75) Inventors: Masahiro Ochiai, Kanagawa (JP); Hiromasa Suzuki, Kanagawa (JP); Michihiko Oowa, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/046,615

(22) Filed: Mar. 12, 2008

(30) Foreign Application Priority Data
Mar. 14, 2007 (JP) 2007-064949

(51) Int. Cl. F21V 5/02; F21V 7/04

(52) U.S. Cl. 362/620; 362/339

(57) ABSTRACT

A light guide plate for uniformly emitting light from an entire face using light taken in through an end face, includes: a parent prism formed on a face opposing to a light emitting face of the light guide plate; and a child prism formed on an inclined face of the parent prism on the end face side of the light guide plate; wherein the parent prism and the child prism convert the advancing direction of the light taken in through the end face so that the light is emitted from the light emitting face.

### CROSS REFERENCES TO RELATED APPLICATIONS

The present invention contains subject matter related to Japanese Patent Application JP 2007-064949 filed with the Japan Patent Office on Mar. 14, 2007, the entire contents of which being incorporated herein by reference.

### BACKGROUND OF THE INVENTION

1. Field of the Invention

This invention relates to a light guide plate, a display apparatus configured using the light guide plate, and an electronic device in which the display apparatus is incorporated.

2. Description of the Related Art

Generally, in an electronic device such as a portable telephone set or a PDA (Personal Digital Assistant), a backlight unit of a liquid crystal display apparatus is formed using a light guide plate. The light guide plate is formed in a shape of a plate from an optically transparent material such as a methyl methacrylate resin (PMMA) material. The light guide plate introduces light taken in through an end face thereof to an entire face thereof utilizing total reflection on front and rear faces thereof and then changes the advancing direction of the light by means of recesses or projections on one of the front and rear faces until the light exhibits an angle smaller than the total reflection angle with respect to and come out from the other face or light emitting face thereby to emit light from the overall area of the light emitting face.

Where a liquid crystal display apparatus is configured using such a light guide plate as described above, in order to effectively guide light from the light guide plate to a liquid crystal panel, usually a lens sheet, a prism sheet or the like having a function of carrying out light distribution, light condensation and so forth is interposed between the light guide plate and the liquid crystal panel. A liquid crystal display apparatus of the type just described is disclosed, for example, in Japanese Patent Laid-open No. 2006-47795.

### SUMMARY OF THE INVENTION

However, if a lens sheet, a prism sheet or the like is interposed, then the thickness dimension of the liquid crystal display apparatus increases by an amount corresponding to the interposed sheet. Therefore, the provision of a lens sheet, a prism sheet or the like is not preferable from a point of view of implementing downsizing and cost reduction of an electronic device which incorporates the liquid crystal display apparatus.

In this regard, it seems a possible idea, for example, to form a light guide plate such that a prism formed on the bottom face thereof directs light vertically uprightly thereby to eliminate the necessity for the intervention of a lens sheet, a prism sheet or the like. However, only if the prism merely directs light vertically upwardly, since converging light looks like a spot due to the directivity of the light, it is difficult to assure light uniformity over the overall face of the light guide plate.

Therefore, it is demanded to provide a light guide plate, a display apparatus and an electronic device which can achieve reduction in size and cost and so forth and besides can implement a uniform planar light source free from luminance irregularity.

According to an embodiment of the present invention, there is provided a light guide plate for uniformly emitting light from an entire face thereof using light taken in through an end face thereof. A light guide plate includes a parent prism formed on a face opposing to a light emitting face of the light guide plate and a child prism formed on an inclined face of the parent prism on the end face side of the light guide plate. The parent prism and the child prism convert the advancing direction of the light taken in through the end face so that the light is emitted from the light emitting face.

With the light guide plate, not only the parent prism but also the child prism formed on the inclined face of the parent prism convert the advancing direction of the light. Accordingly, for example, even where the parent prism is formed in order to emit light taken in through the end face from the light emitting face and consequently the light after the conversion of the advancing direction by the parent prism becomes converging light, the converging light can be converted into diffused light by the presence of the child prism, that is, by the conversion of the advancing direction of the light by the child prism.

According to another embodiment of the present invention, there is provided a light guide plate for uniformly emitting light from an entire face thereof using light taken in through an end face thereof. The light guide plate includes a parent prism formed on a face opposing to a light emitting face of the light guide plate and configured to convert the advancing direction of the light taken in through the end face so that the light is emitted from the light emitting face. The light guide plate further includes an auxiliary prism formed on the downstream side of the parent prism in the advancing direction of light so as to project from the face opposing to the light emitting face and configured to convert the advancing direction of the light having passed through the parent prism so that the light is totally reflected by the light emitting face or the face opposing to the light emitting face.

With the light guide plate, the auxiliary prism is formed adjacent the parent prism. The auxiliary prism converts the advancing direction of the light having passed through the parent prism so that the light is totally reflected by the light emitting face of the light guide plate or the face opposing to the light emitting face. Accordingly, for example, even where the light having passed through the parent prism is emitted toward a direction in which the light does not contribute to enhancement of the emission efficiency of light from the light emitting face, the light can be totally reflected by the light emitting face or the face opposing to the light emitting face by the presence of the auxiliary prism, that is, by the conversion of the light advancing direction by the auxiliary prism. So the light can be emitted toward a direction in which the light contributes enhancement of the emission efficiency of light from the light emitting face by the later conversion of the light advancing direction by the parent prism.

Accordingly, with the light guide plates of the present embodiment, since the parent prism converts the advancing direction of light taken in through the end face so that the light is emitted from the light emitting face, a display apparatus can be configured without the necessity for intervention of a lens sheet, a prism sheet or a like member. Therefore, increase of the thickness dimension of the display apparatus can be prevented, and also implementation of reduction in size, cost and so forth of an electronic device in which the display apparatus is incorporated is facilitated. Besides, since, even in this instance, light in the emission direction is converted into diffused light by the presence of the child prism, such a situation that the light looks like a spot formed from converging light can be prevented, and consequently, luminous uniformity over the overall area of the light emitting face can be assured. Further, since the emission efficiency of light from the light emitting face is enhanced by the presence of the auxiliary prism, uniform planar light emission free from luminance irregularity can be achieved. In other words, it is possible to implement a uniform planar light source which can achieve reduction in size, cost and so forth and besides can implement a uniform planar light source free from luminance irregularity.

### BRIEF DESCRIPTION OF THE DRAWINGS

FIGS. 1A to 1G are schematic views showing an example of a configuration of a portable telephone set as a particular example of an electronic device to which the present embodiment is applied;

FIG. 2 is an exploded perspective view showing an example of a configuration of a backlight type liquid crystal display apparatus interposed in the portable telephone set;

FIGS. 3A and 3B are schematic views showing an example of a configuration of a light guide plate to which the present embodiment is applied;

FIGS. 4 and 5 are schematic views illustrating a particular example of a fabrication process of the light guide plate;

FIGS. 6A and 6B are schematic views illustrating an example of a luminous intensity distribution action of a light guide plate having an existing configuration;

FIGS. 7 to 9B are schematic views showing particular examples of a luminous intensity distribution action of the light guide plate to which the present embodiment is applied;

FIGS. 10A to 10D are schematic views showing a particular example of formation of a parent prism and child prisms on the light guide plate to which the present embodiment is applied;

FIGS. 11A and 11B are schematic views showing a particular example of a luminous intensity distribution action where an angular portion of a recessed portion of a prism is rounded;

FIGS. 12 to 13B are schematic views showing a different particular example of a luminous intensity distribution action of the light guide plate to which the present embodiment is applied;

FIG. 14 is a schematic view illustrating a particular example of formation of an auxiliary prism on the light guide plate to which the present embodiment is applied; and

FIGS. 15A and 15B are schematic views illustrating a further particular example of a luminous intensity distribution action of the light guide plate to which the present embodiment is applied.

### DETAILED DESCRIPTION OF THE PREFERRED EMBODIMENT

In the following, a light guide plate, a display apparatus and an electronic device to which the present embodiment is applied are described with reference to the accompanying drawings.

### [Configuration of the Electronic Device]

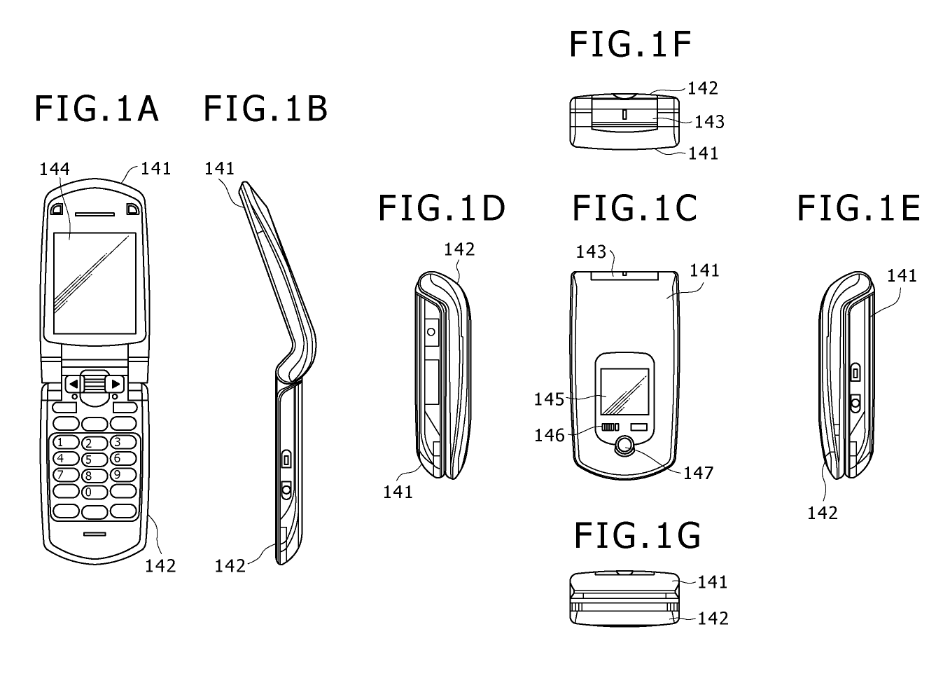

First, the electronic device to which the present embodiment is applied is described. The electronic device of the present embodiment may typically be a portable telephone set. Referring first to FIGS. 1A to 1G, there is shown an example of a configuration of the portable telephone set. The portable telephone set includes an upper side housing 141, a lower side housing 142, a connection section 143 in the form of a hinge section, a display section 144, a sub display section 145, a picture light 146, and a camera 147. The display apparatus to which the present embodiment is applied can be incorporated as the display section 144 or the sub display section 145.

It is to be noted that the electronic device to which the present embodiment may be applied, in addition to a portable telephone set, particularly to a digital camera, a notebook type personal computer, a video camera and so forth if it is configured by incorporating the display apparatus to which the present embodiment is applied.

### [Configuration of the Display Apparatus]

Now, a display apparatus used in such an electronic device as described above, that is, the display apparatus to which the present embodiment is applied, is described. The display apparatus to which the present embodiment is applied is formed as a liquid crystal display apparatus of the backlight type which includes a light guide plate which uses light taken in through an end face thereof to emit light uniformly from an entire face thereof.

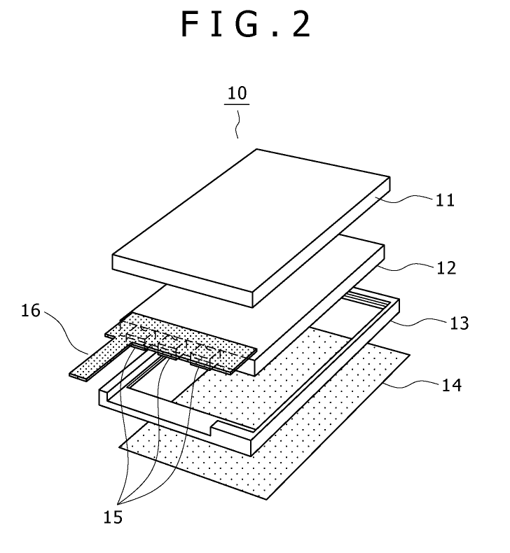

FIG. 2 shows an example of a configuration of the liquid crystal display apparatus of the backlight type. Referring to FIG. 2, the liquid crystal display apparatus 10 includes a liquid crystal panel 11, a light guide plate 12, a resin frame 13 and a reflecting sheet 14 stacked in order.

The liquid crystal panel 11 forms the display section 144 or the sub display section 145.

The light guide plate 12 has a plurality of white LEDs 15 disposed on one end face thereof such that light from the white LEDs 15 is used to emit light from an entire face of the light guide plate 12 so that the light guide plate 12 functions as a backlight of the liquid crystal panel 11. In particular, a plurality of white LEDs 15 are arrayed linearly on a flexible printed circuit board (FPC) 16 on the one end face of the light guide plate 12 so that they may function as a primary light source. It is to be noted that cold cathode fluorescent lamps may be used as the primary light source in place of the white LEDs 15.

The resin frame 13 has a shape of a framework and supports the liquid crystal panel 11, light guide plate 12 and reflecting sheet 14 thereon such that the light emitting face of the light guide plate 12 is opposed to the liquid crystal panel 11.

The reflecting sheet 14 has a form of a thin sheet having a high reflectivity such as an ESR reflection film by Sumitomo 3M Limited and is disposed in the proximity of a face of the light guide plate 12 opposing to the light emitting face of the light guide plate 12.

It is to be noted here that, while, in the liquid crystal display apparatus 10 shown in FIG. 2, one light guide plate 12 is disposed corresponding to one liquid crystal panel 11, the display apparatus to which the present embodiment is applied may otherwise be configured such that two liquid crystal panels corresponding to the display section 144 and the sub display section 145 share one light guide plate 12.

### [Configuration of the Light Guide Plate]

The display apparatus to which the present embodiment is applied and which has the configuration described above is characterized particularly in the light guide plate 12 which forms the display apparatus. Here, the light guide plate 12 used in the display apparatus, that is, the light guide plate 12 to which the present embodiment is applied, is described in detail.

The light guide plate 12 is formed in a shape of a plate from a light transmitting material and is generally configured in the following manner. In particular, the plate-shaped light guide plate 12 introduces light taken in from the white LEDs 15 disposed on the one end face thereof to the overall area of the light guide plate 12 making use of total reflection by the front face or the rear face of the plate. The light guide plate 12 changes the advancing direction of the light using prisms formed on one of the opposite faces thereof so that it comes to the other face or light emitting face at an angle smaller than the total reflection angle and goes out from the light emitting face. The light guide plate 12 utilizes this phenomenon to emit light from the entire light emitting face. While the light transmitting material may popularly be PMMA, a polycarbonate (PC) resin material, a cycloolefin-based resin material or a like resin material may be used instead. Further, the “formation in a shape of a plate” includes not only to form the light guide plate so as to have a uniform thickness over the overall area thereof but also to form the light guide plate so as to have a tapering shape with which the thickness decreases away from the white LEDs 15.

Incidentally, it is necessary to configure the light guide plate 12 such that recesses or projections such as prisms or reflecting dots are formed on a face of the light guide plate 12 opposing to the light emitting face such that the advancing direction of light taken in through the end face of the light guide plate 12 is changed so that the light is emitted from the light emitting face. While the light guide plate 12 shown has prisms formed as such recesses or projections as described above thereon, it is characterized most in the prisms.

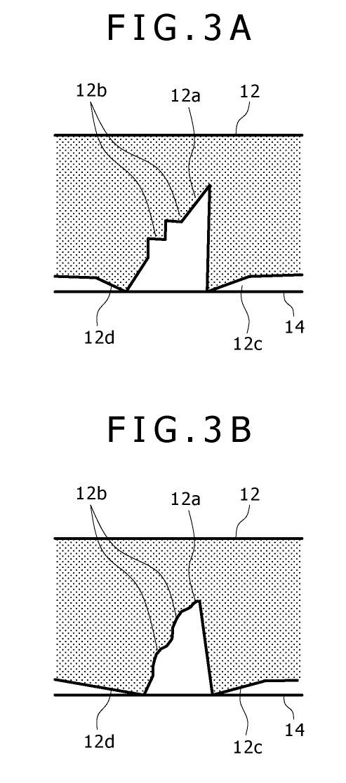

FIGS. 3A and 3B show an example of a configuration of the light guide plate to which the present embodiment is applied.

Referring to FIG. 3A, the light guide plate 12 has a prism portion 12a formed on the face thereof opposing to the light emitting face thereof and adjacent the reflecting sheet 14 by cutting away the material of the light guide plate 12 in a triangular shape in cross section. The prism portion 12a is hereinafter referred to as parent prism 12a. Although only one parent prism 12a is shown provided on the light guide plate 12 in FIG. 3, actually the light guide plate 12 has a plurality of such parent prisms 12a formed therefor. Further, the light guide plate 12 has another prism portion 12b formed on an inclined face of the parent prism 12a adjacent the white LEDs 15 by cutting away the material of the light guide plate 12 in a triangular shape in cross section similarly to the parent prism 12a. The prism portion 12B is hereinafter referred to as child prism 12B. While the light guide plate 12 shown in FIG. 3A has two such child prisms 12b formed thereon, the number of such child prisms 12b may be at least one for each one parent prism 12a. The light guide plate 12 thus converts the advancing direction of light taken in through the end face thereof in such a manner as hereinafter described by means of the parent prisms 12a and the child prisms 12b so that the light is emitted from the light emitting face of the light guide plate 12.

The light guide plate 12 further has a different prism portion 12c of a triangular shape in cross section formed adjacent the parent prism 12a on the downstream side of the parent prism 12a in the light advancing direction such that it projects from the face of the light guide plate 12 opposing to the light emitting face. The prism portion 12c is hereinafter referred to as auxiliary prism 12c. The projection amount of the auxiliary prism 12c is set so that the gap between the light guide plate 12 and the reflecting sheet 14 may be substantially filled up. The auxiliary prism 12c converts the advancing direction of light having passed through the parent prism 12a so that the light is totally reflected by the light emitting face of the light guide plate 12 or the face opposing to the light emitting face as hereinafter described in detail.

Furthermore, the light guide plate 12 has another different prism portion 12d of a triangular shape in cross section formed adjacent the parent prism 12a on the upstream side of the parent prism 12a in the light advancing direction such that it projects from the face of the light guide plate 12 opposing to the light emitting face. The prism portion 12d is hereinafter referred to as second auxiliary prism 12d. The second auxiliary prism 12d formed on the light guide plate 12 increases components which contribute to light source side luminous intensity distribution.

It is to be noted that the parent prism 12a and the child prisms 12b need not necessarily have a sharp vertex angle but may be rounded at a vertex angle, for example, as seen in FIG. 3B. This similarly applies also to the auxiliary prism 12c and the second auxiliary prism 12d.

The light guide plate 12 having such a configuration as described above can be produced by a mechanical machining method such as cutting or a laser machining method which makes use of a laser beam to carve recesses or projections. However, in order to produce the light guide plate 12 in a high efficiency, a photolithography technique and a metal mold making technique may be utilized for the production of the light guide plate 12.

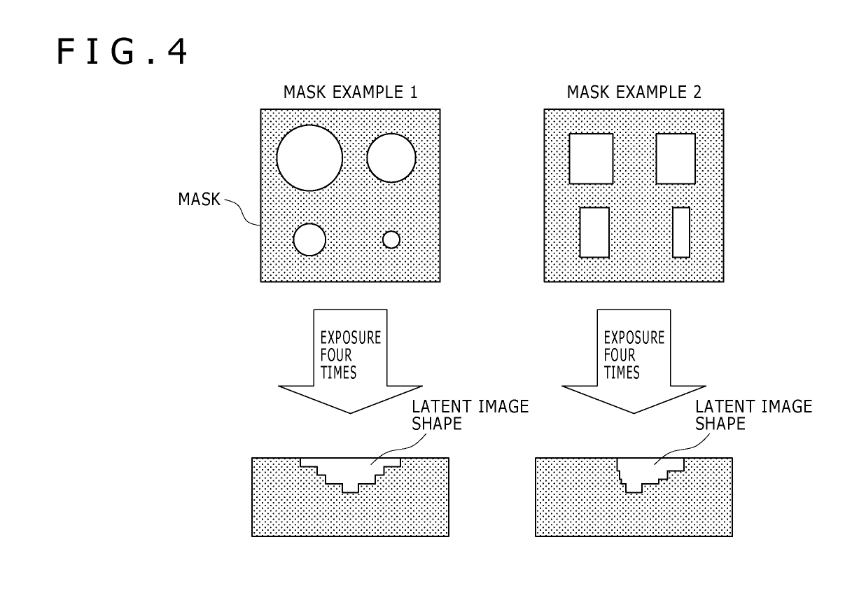

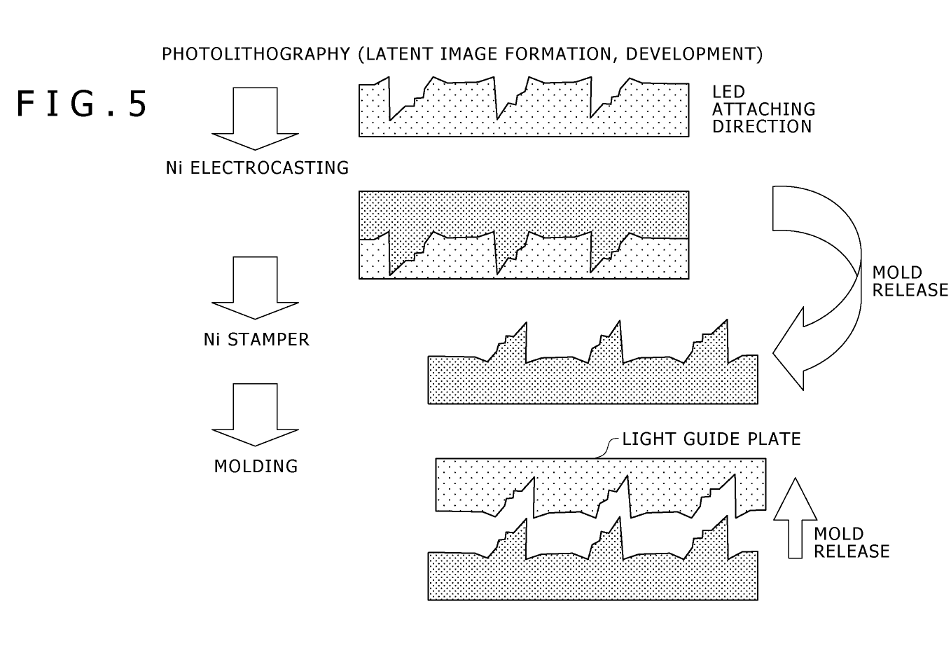

FIGS. 4 and 5 illustrate a particular example of a production process of the light guide plate 12.

Where a photolithography technique and a metal mold making technique are used to produce the light guide plate 12, the photolithography technique is first utilized to form a latent image as seen in FIG. 4. In particular, if aperture patterns of different sizes are placed concentrically and exposed to light successively, for example, four times, then a latent image of a stereoscopic shape is formed. Then, the latent image is developed to produce shapes corresponding to the individual prisms. After the latent image formation and the development are carried out as described above, a Ni pattern of a shape complementary to the shape of the result of the latent image formation is obtained, for example, by Ni electrocasting. Then, the Ni stamper is utilized to carry out metal mold making, for example, of a UV curing resin to produce the light guide plate 12.

[Luminous Intensity Distribution Action of the Light guide plate]

Now, a luminous density distribution action of the light guide plate 12 having such a configuration as described above is described.

### [Luminous Intensity Distribution Action of a Light Guide Plate of an Existing Configuration]

First, a luminous intensity distribution action of a light guide plate of a existing configuration is described for comparison with that of the light guide plate 12.

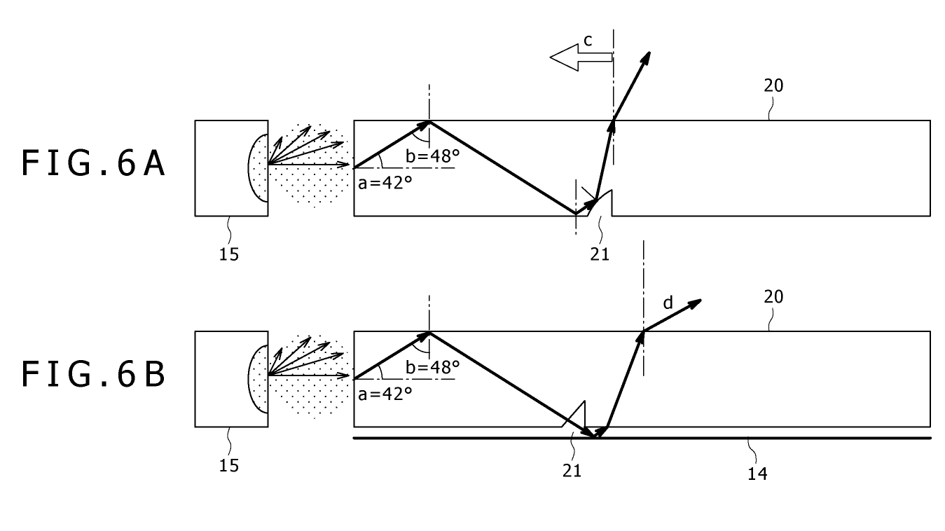

FIGS. 6A and 6B illustrate an example of a luminous intensity distribution action of a light guide plate of a existing configuration. The light guide plate 20 in this instance is formed using PMMA of a refraction index n=1.492 as a material and has a prism 21 which merely directs light upwardly.

As seen in FIGS. 6A and 6B, if light is introduced into such a light guide plate 20 as described above from a white LED 15 disposed adjacent an end face of the light guide plate 20, then since 1.0·sin 90°=1.492·sin θ from the calculation expression of refraction of light, the angle a of the incoming light with respect to a normal to the incidence face becomes within ±42°. The light incoming at the angle a within ±42° exhibits an angle b of more than 48° with respect to a normal to the upper face or light emitting face of the light guide plate 20. Since the angle b is greater than the critical angle 42°, if the upper face and the bottom face of the light guide plate 20 extend in parallel to each other, then the light successively undergoes total reflection by and between the two faces of the light guide plate 20.

Then, when the light comes to the prism 21 formed on the bottom face of the light guide plate 20, then the advancing direction thereof is changed by an inclined face of the prism 21 in accordance with the law of refraction and reaches the upper face of the light guide plate 20 at an angle smaller than the critical angle as seen in FIG. 6A. Consequently, the light from the white LED 15 is emitted vertically uprightly from the light emitting face of the light guide plate 20. However, if only one inclined face of the prism 21 is merely used to change the light advancing direction, then it is difficult to implement refraction of the light toward a direction back to the white LED 15 side as the light source with respect to the normal (refer to an arrow mark c in FIG. 6A). Therefore, if light is merely directed vertically upwardly by the prism 21, then the luminous intensity distribution to the white LED 15 side is reduced by the directivity of the light described above. As a result, convergence light may look like a dot, and this makes it difficult to assure the uniformity of light over the overall area of the light guide plate 20.

Further, when the totally reflected light comes to the prism 21 formed on the bottom face of the light guide plate 20, part of the light passes through the inclined face of the prism 21 and makes a component which hits the reflecting sheet 14 as seen in FIG. 6B. Meanwhile, if the total reflection of the light by the bottom face of the light guide plate 20 is taken into consideration, then it is necessary to assure a certain fixed gap between the bottom face of the light guide plate 20 and the reflecting sheet 14. Accordingly, the light having passed through the prism 21 and hitting the reflecting sheet 14 enters, after it is reflected by the reflecting sheet 14, the flat bottom face of the light guide plate 20 past the fixed gap. Then, the entering light is not totally reflected by the upper face of the light guide plate 20 but goes out in an oblique direction from the upper face. Such leakage light in the oblique direction (refer to an arrow mark d in FIG. 6B) decreases the utilization efficiency of the light from the white LED 15 and may possibly make a cause of occurrence of luminance irregularity upon oblique observation.

### [Luminous Intensity Distribution Action Achieved by the Parent Prism and the Child Prism]

In contrast to the light guide plate 20 of such a configuration as described above, the light guide plate 12 to which the present embodiment is applied achieves such a luminous intensity distribution action as described below because the advancing direction of light is converted by the parent prism 12a and the child prisms 12b.

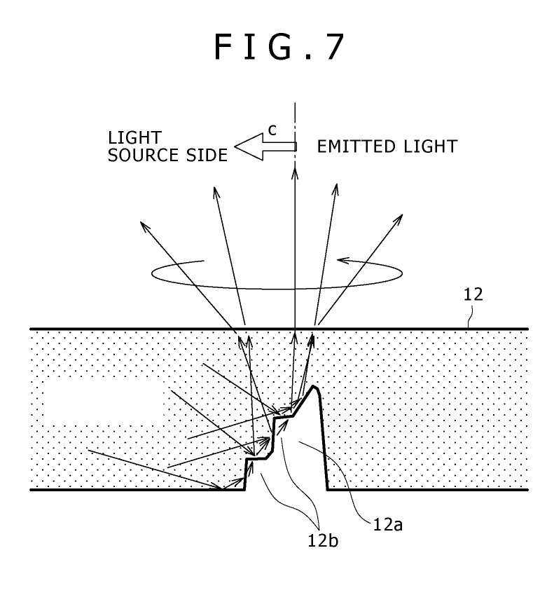

FIGS. 7, 8A, 8B, 9A and 9B illustrate particular examples of a luminous intensity distribution action of the light guide plate 12 to which the present embodiment is applied.

In the light guide plate 12 to which the present embodiment is applied, not only the parent prism 12a but also the child prisms 12b formed on the inclined face of the parent prism 12a convert the advancing direction of light. In particular, not only the inclined face of the parent prism 12a but also the inclined face of each child prism 12b change the advancing direction of light in accordance with the law of refraction. Accordingly, even where it is difficult to use only the parent prism 12a to refract light toward a direction back to the white LED 15 side with respect to a normal (refer to an arrow mark c in FIG. 7), light components which refract toward the direction described can be assured sufficiently by utilizing the conversion of the light advancing direction by means of the child prisms 12b.

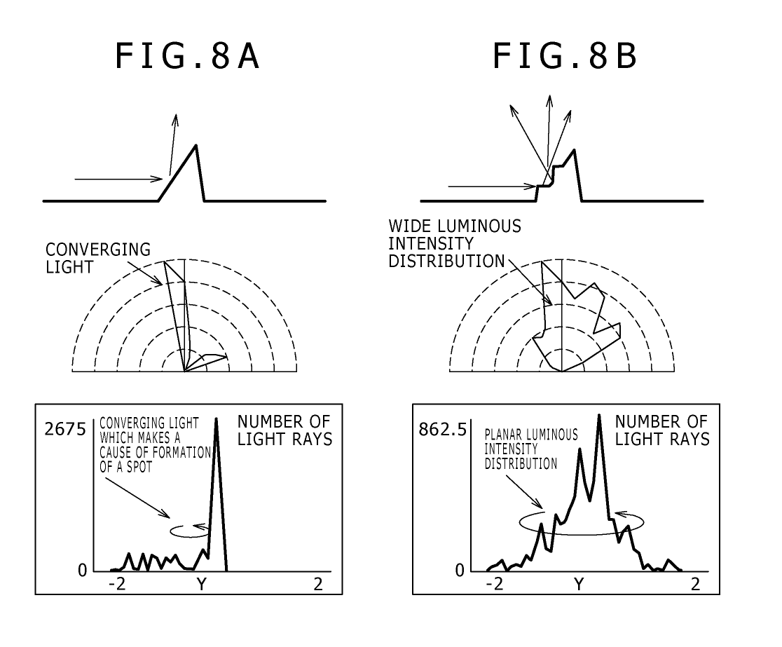

This signifies that, also where light after the conversion of the advancing direction only by the parent prism 12a becomes converging light as seen in FIG. 8A, the converging light can be converted into diffused light as seen in FIG. 8B by the presence of the child prisms 12b, that is, by the conversion of the light advancing direction by the child prisms 12b. In other words, by the presence of the child prism 12b, converging light which makes a cause of a phenomenon that light looks like a spot can be converted into diffused light which has wide orientation and exhibits uniform light distribution.

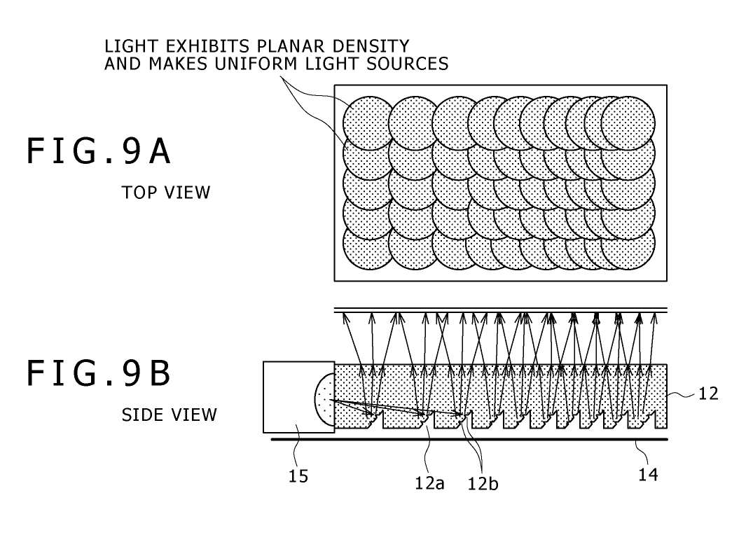

With such diffused light as described above, emitted light from the light emitting face forms dense planar light sources as seen in FIGS. 9A and 9B. In other words, by utilizing the child prisms 12b to produce diffused light, planar light sources of high uniformity can be implemented. Besides, to this end, there is no necessity for the intervention of a lens sheet, a prism sheet or a like element as is demanded in an existing light guide plate.

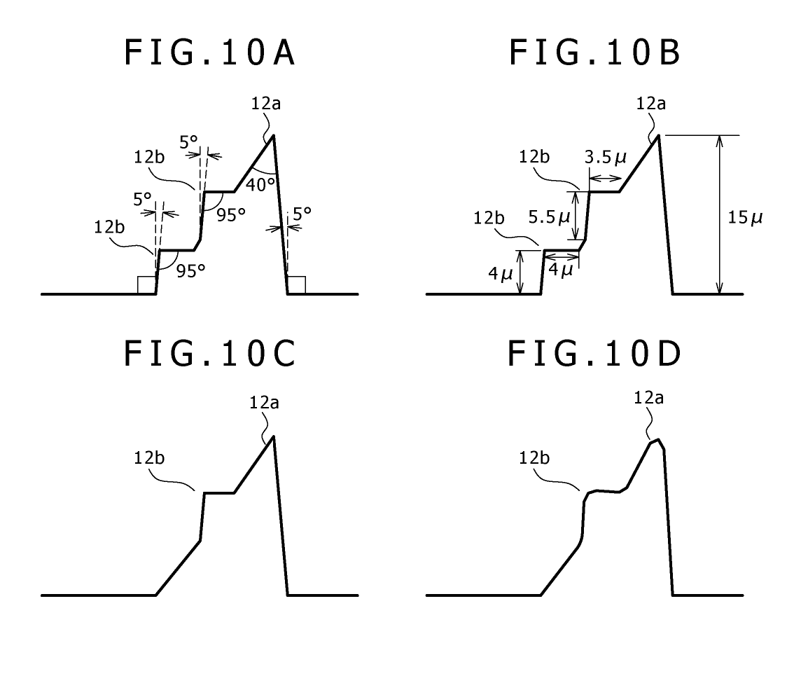

The parent prism 12a and the child prisms 12b for implementing such a luminous intensity distribution action as described above may particularly be such as that illustrated in FIGS. 10a and 10b. In particular, where the light guide plate 12 is formed using, for example, PMMA of a refractive index n=1.492, the parent prism 12a and the child prisms 12b are formed so as to have such angles as seen in FIG. 10a and have such dimensions as seen in FIG. 10b. However, the number of child prisms 12b to be formed need not necessarily be two, but at least one child prism 12b may be formed per one parent prism 12a as seen in FIG. 10C.

Further, the parent prism 12a and the child prisms 12b do not necessarily have a sharp vertex angle but may otherwise have an arcuately rounded vertex, for example, as seen in FIG. 10D. This is because, where the light guide plate 12 is produced, for example, by molding of a resin material, the vertex may possibly be rounded in the process.

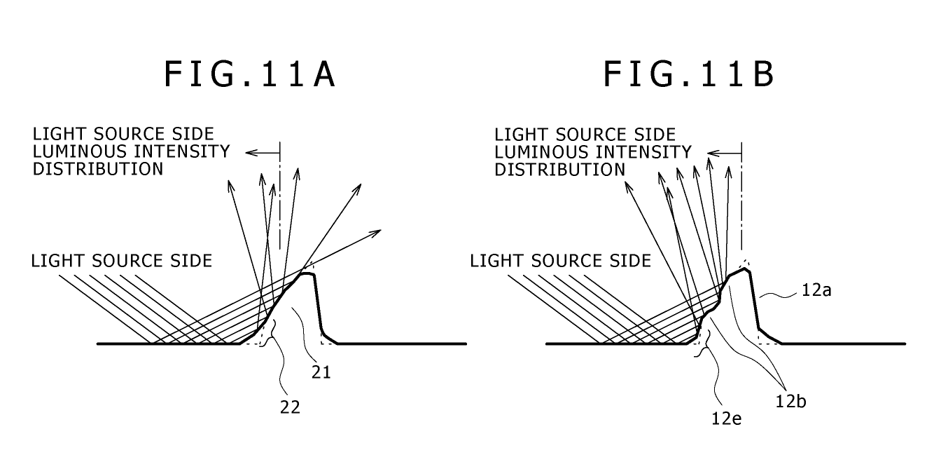

Incidentally, upon molding, not only a vertex portion but also a recessed portion may be rounded at an angular portion thereof. Such a rounded angular portion as just described may possibly make a factor which reduces the light source side luminous intensity distribution. FIGS. 11A and 11B illustrate particular examples of a luminous intensity distribution action where an angular portion of a recessed portion is rounded.

For example, if an angular portion 22 on the upstream side in the light advancing direction with respect to the prism 21 in a light guide plate of an existing configuration is rounded, then since steep upright light components from the bottom face of the light guide plate 20 are not obtained when compared with those where the angular portion 22 is not rounded, the light source side luminous intensity distribution decreases.

However, where the parent prism 12a and the child prisms 12b are used to convert the advancing direction of light as seen in FIG. 11B, even if an angular portion 12e is rounded upon molding, light components corresponding to steep upright light components with respect to the bottom face of the light guide plate can be assured by the inclined face of the child prisms 12b. Therefore, reduction of the light source side luminous intensity distribution can be prevented. In other words, with the light guide plate 12 configured with the parent prism 12a and the child prisms 12b formed thereon, light components which are refracted toward the light source side can be assured sufficiently irrespective of whether or not an angular portion is rounded upon molding.

### [Luminous Intensity Distribution Action Achieved by the Auxiliary Prism]

Further, since the light guide plate 12 according to the present embodiment has the auxiliary prism 12c adjacent the parent prism 12a when compared with the light guide plate 20 of the existing configuration described hereinabove, the following luminous intensity distribution can be anticipated.

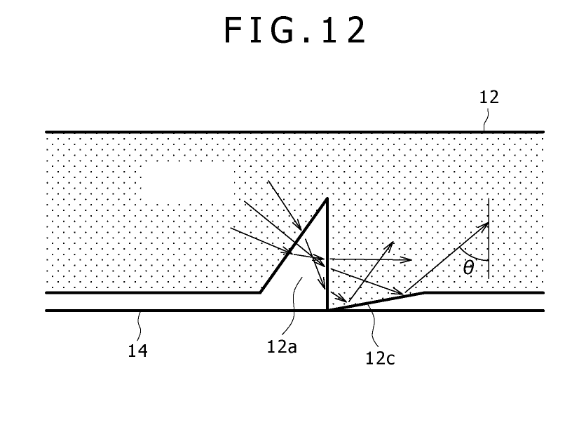

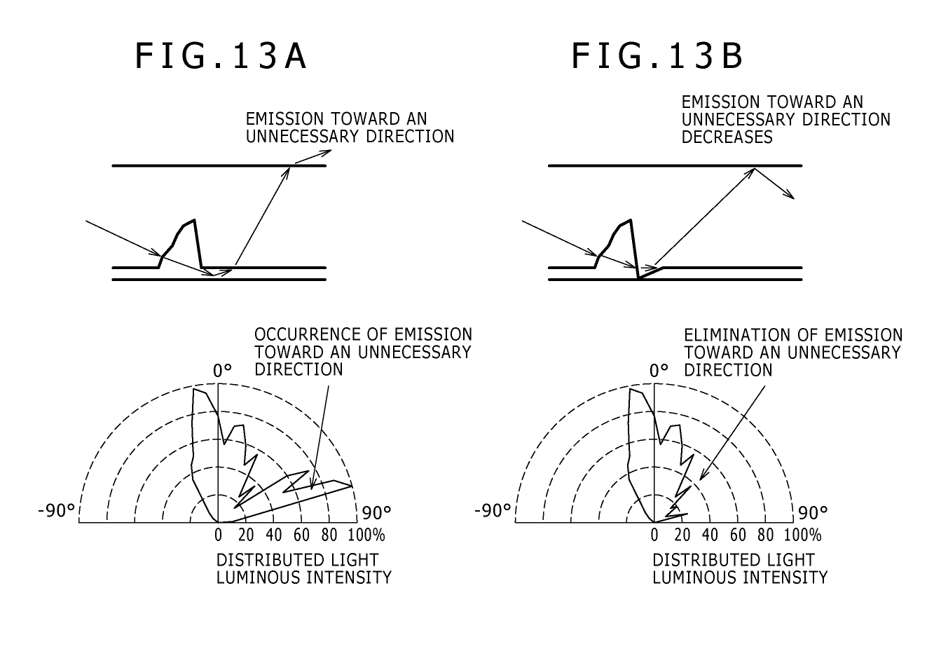

FIGS. 12, 13A and 13B illustrate another example of the luminous intensity distribution action of the light guide plate according to the present embodiment.

In the light guide plate 12 according to the present embodiment, the auxiliary prism 12c provided adjacent the parent prism 12a projects toward the reflecting sheet 14 such that it substantially fills up the gap between the light guide plate 12 and the reflecting sheet 14 as seen in FIG. 12. The auxiliary prism 12c converts the advancing direction of light having passed through the parent prism 12a. In other words, by the presence of the auxiliary prism 12c, light components which directly hit the reflecting sheet 14 are reduced. Then, the auxiliary prism 12c converts the advancing direction of light having passed through the parent prism 12a so that the light may be reflected totally by the light emitting face of the light guide plate 12 or the face opposing to the light emitting face. More particularly, the advancing direction of the light having passed through the parent prism 12a is converted so that θ≧light guide plate critical angle (in the case of PMMA, 42.2°) may be satisfied.

This signifies that, also where the light having passed through the parent prism 12a and reflected by the reflecting sheet 14 can be emitted toward an unnecessary direction by the presence only of the parent prism 12a as seen in FIG. 13A, the light having passed through the parent prism 12a is totally reflected by the light emitting face of the light guide plate 12 or the face opposing to the light emitting face as seen in FIG. 13B by the presence of the auxiliary prism 12c, that is, by the conversion of the advancing direction of the light by the auxiliary prism 12c. In other words, it is possible to suppress emission of light toward an unnecessary direction and cause light to emit toward a direction in which the light contributes to enhancement of the light emission efficiency from the light emitting face.

If light emission toward an unnecessary direction from the light emitting face of the light guide plate 12 is suppressed thereby to enhance the light emission efficiency from the light emitting face, then the light guide plate 12 can implement uniform planar light emission free from irregularity in luminance.

Besides, since only a vertex portion of the auxiliary prism 12c fills up the gap between the reflecting sheet 14 and the light guide plate 12 while the gap between the bottom face of the light guide plate 12 and the reflecting sheet 14 is assured at any other location, obstruction to total reflection of light by the bottom face of the light guide plate 12 is prevented.

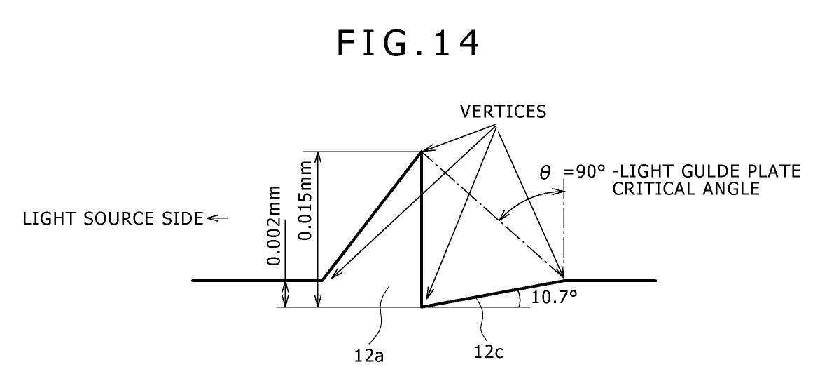

The light guide plate 12 which implements such a luminous intensity distribution action as described above may particularly be such as shown in FIG. 14. Where the light guide plate 12 is formed using, for example, PMMA of a refractive index n=1.492 as a material, the auxiliary prism 12c may be formed so as to have such angles and dimensions as seen in FIG. 14. It is to be noted that each vertex need not necessarily have a sharp vertex angle but may be rounded arcuately.

Further, although the child prisms 12b are not shown in FIG. 14, even where such child prisms 12b exist, naturally a similar luminous intensity distribution action can be achieved.

### [Luminous Intensity Distribution Action Achieved by the Second Auxiliary Prism]

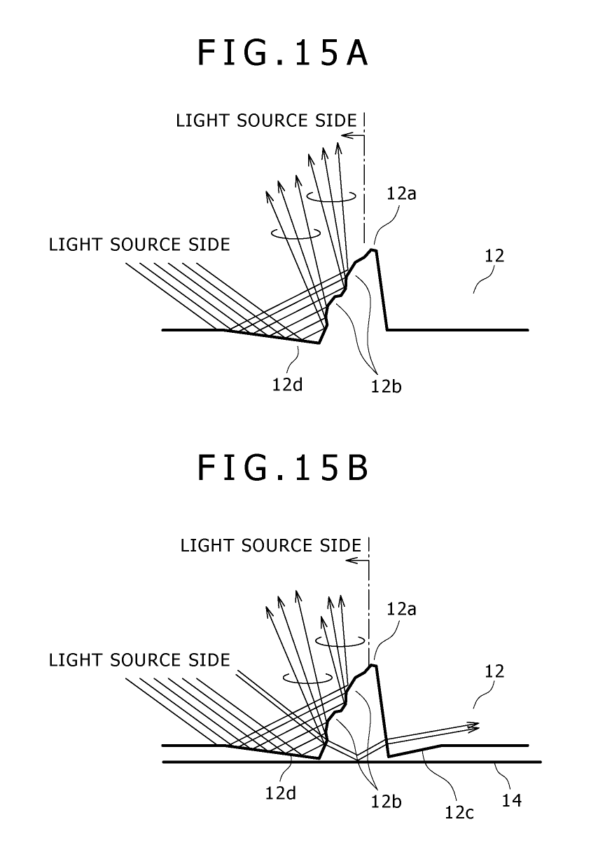

Further, the light guide plate 12 to which the present embodiment is applied achieves such a luminous intensity distribution action as described below because it has the second auxiliary prism 12d provided thereon. FIGS. 15A and 15B illustrate a further particular example of the light guide plate according to the present embodiment by which a luminous intensity distribution action can be achieved.

In the light guide plate 12 according to the present embodiment, since the second auxiliary prism 12d is provided adjacent the parent prism 12a as seen in FIG. 15A, the incidence angle of light incoming to the parent prism 12a and the child prisms 12b is deep when compared with that in an alternative case wherein no second auxiliary prism 12d is provided. Accordingly, where the second auxiliary prism 12d is provided, light components which contribute to light source side luminous intensity distribution increases when compared with those in an alternative case wherein the second auxiliary prism 12d is not provided.

Further, where both of the auxiliary prism 12c and the second auxiliary prism 12d are provided adjacent the parent prism 12a as seen in FIG. 15B, emission of light toward an unnecessary direction, that is, obliquely emitted light, from the light emitting farce of the light guide plate 12 is suppressed by the luminous intensity distribution by the auxiliary prism 12c as described hereinabove. Therefore, light components which contribute to the light source side luminous intensity distribution increase relatively. In other words, it is possible to increase light components which contribute to the light source side luminous intensity distribution in addition to making the incidence angle of light to the parent prism 12a and so forth deeper.

While a preferred embodiment of the present invention has been described using specific terms, such description is for illustrative purpose only, and it is to be understood that changes and variations may be made without departing from the spirit or scope of the following claims.

For example, while, in the embodiment described above, all of the parent prism 12a, child prism 12b, auxiliary prism 12c and second auxiliary prism 12d are formed on the light guide plate 12, it is otherwise possible, for example, to provide only the parent prism 12a and the child prism 12b or to provide only the parent prism 12a and the auxiliary prism 12c. Also in such cases, a uniform planar light source which does not cause luminance irregularity can be implemented while facilitating reduction in size and cost and so forth when compared with a light guide plate of an existing configuration.

What is claimed is:

1. A light guide plate for uniformly emitting light from an entire face using light taken in through an end face, comprising:
a parent prism formed on a face opposing to a light emitting face of said light guide plate; and
a child prism formed on an inclined face of said parent prism on the end face side of said light guide plate; wherein
said parent prism and said child prism convert the advancing direction of the light taken in through the end face so that the light is emitted from the light emitting face.

2. The light guide plate according to claim 1, further comprising a second auxiliary prism formed on the upstream side of said parent prism in the advancing direction of light so as to project from the face opposing to the light emitting face.

3. A light guide plate for uniformly emitting light from an entire face using light taken in through an end face, comprising:
a parent prism formed on an face opposing to a light emitting face of said light guide plate and configured to convert the advancing direction of the light taken in through the end face so that the light is emitted from the light emitting face; and
an auxiliary prism formed on the downstream side of said parent prism in the advancing direction of light so as to project from the face opposing to the light emitting face and configured to convert the advancing direction of the light having passed through said parent prism so that the light is totally reflected by the light emitting face or the face opposing to the light emitting face.

4. The light guide plate according to claim 2, further comprising a second auxiliary prism formed on the upstream side of said parent prism in the advancing direction of light so as to project from the face opposing to the light emitting face.

5. A light guide plate for uniformly emitting light from an entire face using light taken in through an end face, comprising:
a parent prism formed on a face opposing to a light emitting face of said light guide plate;
a child prism formed on an inclined face of said parent prism on the end face side of said light guide plate; and
an auxiliary prism formed on the downstream side of said parent prism in the advancing direction of light so as to project from the face opposing to the light emitting face; wherein
said parent prism and said child prism convert the advancing direction of the light taken in through the end face so that the light is emitted from the light emitting face, said auxiliary prism converts light having passed through said parent prism so that the light is totally reflected by the light emitting face or the face opposing to the light emitting face.

6. The light guide plate according to claim 5, further comprising a second auxiliary prism formed on the upstream side of said parent prism in the advancing direction of light so as to project from the face opposing to the light emitting face.

7. A display apparatus, comprising
a light guide plate for uniformly emitting light from an entire face using light taken in through an end face;
said light guide plate including
a parent prism formed on a face opposing to a light emitting face of said light guide plate, and
a child prism formed on an inclined face of said parent prism on the end face side of said light guide plate, wherein
said parent prism and said child prism convert the advancing direction of the light taken in through the end face so that the light is emitted from the light emitting face.

8. The display apparatus according to claim 7, wherein said light guide plate further comprises a second auxiliary prism formed on the upstream side of said parent prism in the advancing direction of light so as to project from the face opposing to the light emitting face.

9. A display apparatus, comprising
a light guide plate for uniformly emitting light from an entire face using light taken in through an end face;
said light guide plate including
a parent prism formed on an face opposing to a light emitting face of said light guide plate and configured to convert the advancing direction of the light taken in through the end face so that the light is emitted from the light emitting face, and
an auxiliary prism formed on the downstream side of said parent prism in the advancing direction of light so as to project from the face opposing to the light emitting face and configured to convert the advancing direction of the light having passed through said parent prism so that the light is totally reflected by the light emitting face or the face opposing to the light emitting face.

10. The display apparatus according to claim 9, wherein said light guide plate further comprises a second auxiliary prism formed on the upstream side of said parent prism in the advancing direction of light so as to project from the face opposing to the light emitting face.

11. A display apparatus, comprising
a light guide plate for uniformly emitting light from an entire face using light taken in through an end face;
said light guide plate including
a parent prism formed on a face opposing to a light emitting face of said light guide plate,
a child prism formed on an inclined face of said parent prism on the end face side of said light guide plate, and
an auxiliary prism formed on the downstream side of said parent prism in the advancing direction of light so as to project from the face opposing to the light emitting face, wherein
said parent prism and said child prism convert the advancing direction of the light taken in through the end face so that the light is emitted from the light emitting face, said auxiliary prism converts light having passed through said parent prism so that the light is totally reflected by the light emitting face or the face opposing to the light emitting face.

12. The display apparatus according to claim 11, wherein said light guide plate further comprises a second auxiliary prism formed on the upstream side of said parent prism in the advancing direction of light so as to project from the face opposing to the light emitting face.

13. An electronic device, comprising
a display apparatus including a light guide plate for uniformly emitting light from an entire face using light taken in through an end face;
said light guide plate including
a parent prism formed on a face opposing to a light emitting face of said light guide plate,
a child prism formed on an inclined face of said parent prism on the end face side of said light guide plate, and
an auxiliary prism formed on the downstream side of said parent prism in the advancing direction of light so as to project from the face opposing to the light emitting face, wherein
said parent prism and said child prism convert the advancing direction of the light taken in through the end face so that the light is emitted from the light emitting face, said auxiliary prism converts light having passed through said parent prism so that the light is totally reflected by the light emitting face or the face opposing to the light emitting face.
